(19) United States
(12) Patent Application Publication
(10) Pub. No.: US 2007/0210581 A1
(43) Pub. Date: Sep. 13, 2007

(54) Multi-purpose non-fuel-burning emission-free electrical generators

(76) Inventor: Rudolph V. Bailey SR., Manassas, VA (US)

Correspondence Address: RUDOLPH V. BAILEY CEO;APT 301, 9659 MANASSAS DR., MANASSAS, VA, 20153, US

(21) Appl. No.: 11/801,251

(22) Filed: May 9, 2007

Related U.S. Application Data
(63) Continuation-in-part of application No. 11/394,800, filed on Apr. 1, 2006.
(60) Provisional application No. 60/802,405, filed on May 22, 2006.
(60) Provisional application No. 60/729,292, filed on Oct. 21, 2005.

(51) Int. Cl. F02D 29/06

(52) U.S. Cl. 290/7

(57) ABSTRACT

A continuous operating portable electrical power generator with zero harmful emission and zero recurring fuel cost has been disclosed. This is accomplished by using a gasoline automobile engine which was converted to a non-fuel burning pollution free pneumatic engine in CO-pending application Ser. No. 11/394,800. An automatic clutch assembly is installed in place of the transmission, which drives a 110/220-volt-AC generator. A 220/440-volt-AC transformer can be also installed to give 440-volt-AC. A circuit breaker cabinet is also installed.

### DESCRIPTION OF RELATED APPLICATIONS

This application is a continuation-in-part of CO-pending application Ser. No. 11/394,800 filed Apr. 1, 2006, and replaces Application Ser. No. 60/729,292 filed on Oct. 21, 2005, and abandoned.

### BACKGROUND OF THE INVENTION

This version of the invention is concerned with the field of battery operated devices which converts DC electrical energy to AC electrical energy. More specifically this version of the invention is concerned with A system that utilizes a gasoline automobile engine that was converted in CO-pending application to a pneumatic engine in order to supply the energy for the generator.

### PRIOR ART

Gasoline driven portable electrical generators hove been around for some time, but they hove certain limitations such as they are not suitable for indoor use due to their harmful emissions. Said gasoline driven generators are not suitable for continuous use as one must add fuel to them periodically. In addition the cost of gasoline to operate them on a continuous basis can be significant due to the rising cost of gasoline. The storing of gasoline for their continuous use also poses a safety risk. In short these types of electrical generators are only suitable for use for short duration's in out door environments.

What is needed therefore to overcome these limitations is a way to generate electric for portable long term uses without harmful emissions, or recurring fuel cost.

An example of such device is exemplified in U.S. Pat. No. 5,804,948 System for Zero Emission Generation of Electricy, issued to John W. Frost on Sep. 8, 1998.

Discussion of the Prior Art

As illustrated by background art, efforts are continuously being made in attempts to develop emission free, and fuel free systems to convert DC power to AC power and to extend the operation of the generator beyond the normal battery power cycle. Frost's invention falls short of the intended goal, as his system is inoperable, and violates the second law of thermodynamics, and the laws of energy conversion, and it also makes improper use of component parts. Frost attempted to extend the operating cycle of a 12-volt battery, by installing a 12-volt automobile type alternator to charge one of the two batteries for a 4-hour period, then the next battery for 4-hours back and forth. A comptroller was used to switch the charging from battery to battery. A ¼-HP motor was used to operate said alternator and a 9500 watt DC inverted to AC generator. Frost's system would have to convert the 12-volts from one of the battery to the 15-volts it would take to charge a discharged 12-volt battery. Said operation would violate both the laws of energy conversion and the second law of thermodynamics, as some energy would be lost due to heat and friction. In addition to this, an automobile type alternator is not designed to charge a discharged battery, and a ¼-HP motor is not sufficient to operate a 12-volt alternator when it is in a charge cycle. In addition the said ¼-HP motor would also have to operate a 9500-watt generator at the same time.

No prior effort however provides the benefits attendant with the present invention. As such, it may be appreciated that there is a continuing need for a new and improved method or system to convert DC battery power to AC power on a continuous basis without normal interruption to recharge said battery or batteries, or for re-fueling needs. In this respect, the present version of the invention substantially departs from the conventional concepts, and design of the prior art, and in so doing provides a way to generate AC current from DC current with the support of a pneumatic engine, with zero emissions and zero recurring fuel cost. Additionally, the prior patents and commercial techniques do not suggest the present inventive combination of component elements as arranged and configured as disclosed herein.

The present invention achieves its intended purposes, objects and advantages through a new, useful and unobvious combination of methods steps and component elements, with the use of a minimum number of functioning parts, at a reasonable cost to manufacture, and by employing readily available materials.

### SUMMARY

The present version of the invention which will be described in greater detail herein after, relates to the field of portable devices that can deliver 110/220/440-volt-AC on a continuous basis, with zero emission and zero recurring fuel cost.

Described briefly according to a typical embodiment the invention makes use of an automobile type gasoline engine which was converted in CO-pending continuation-in-part application Ser. No. 11/394,800, filed on Apr. 1, 2006. The said gasoline engine was converted into a pneumatic engine, and an AC generator was added to deliver 110/220-volt AC. A 220-440-volt-AC transformer was also added along with a circuit break cabinet. My version of the invention overcomes all of the shortcomings of the prior art which was previously listed, in addition to novel aspects that will be described in detail hereinafter.

My invention, therefore, resides not in any one of these features per se, but rather in the particular combination of all of them herein disclosed. It is distinguished from the prior art in this particular combination of all of its structures for the functions specified.

In order that the detailed description of the invention may be better understood, and that the present contribution to the art can be more fully appreciated, additional features of the invention will be described hereinafter. It should be appreciated by those skilled in the art that the conception and the disclosed specific methods and structures may be readily utilized as a basis for modifying or designing other structures for carrying out the same purposes of the present invention. It should be realized by those skilled in the art that such equivalent methods and structures do not depart from the spirit and scope of the invention.

In this respect, before explaining at least one embodiment of the invention in detail, it is to be understood that the invention is not limited in its application to the details of construction and to the arrangement of the components set forth in the following description or illustrated in the drawings.

The invention is capable of other embodiments and of being practiced and carried out in various ways. It is also to be understood that the phraseology and terminology employed herein are for the purpose of description, and should not be regarded as limiting.

As such, those skilled in the art will appreciate that the conception, upon which this disclosure is based, may be readily used as a basis for the designing of other structures, methods and systems for carrying out the several purposes of the present invention.

Further, the purpose of the foregoing abstract is to enable the US Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

Accordingly, it is an object of our version of the invention to provide low-cost, easy-to-manufacture, and easy-to-market Multi-purpose Non-fuel burning Emission-free Electrical Power Generators.

A further object of our version of the invention is to provide easy-to-use and versatile and transportable and light weight and quiet Multi-purpose Electrical Generators for use in the transportation Industry, or home or factory or commercial establishments.

A significant object of the invention is also to provide a Multi-purpose heavy-duty high energy Non-fuel-burning Emission-free Electrical Generator that can be used in power plants and large equipment and large transportation devices such as locomotives ships air-craft and such like.

A final but very significant object of the invention is to provide a variety of sizes, and volt and amp and watt ratings to meet various needs and applications where ever power is needed.

For a better understanding of the invention, its operating advantages and the specific objects attained by its uses, reference should be made to the accompanying drawings and descriptive matter in which there is illustrated a preferred embodiment of the invention. The foregoing has outlined some of the more pertinent objects of the invention. These objects should be construed to be merely illustrative of some of the more prominent features and applications of the present invention. Many other beneficial results can be attained by applying the disclosed invention in a different manner, or by modifying the invention within the scope of the disclosure. Accordingly, other objects and a fuller understanding of the invention may be had by referring to the summary of the invention and the detailed description of the preferred embodiment in addition to the scope of the invention illustrated by the accompanying drawings.

### BRIEF DESCRIPTION OF THE DRAWINGS

The foregoing and other objects, features and advantages of the invention will become more fully understood from the following description of the preferred embodiment of the invention as illustrated in the accompanying drawings in which like reference characters refer to the same parts throughout different views. The drawings are not necessarily to scale, emphasis instead being placed upon illustrating the principles of the invention.

FIG. 1 is d plan view of a 4-cylinder converted pneumatic automobile type engine with zero emission no recurring fuel cost, showing the addition of an automatic clutch instead of a transmission, and an AC generator, a transformer and circuit breaker cabinet.

FIG. 2 is an elevation view showing the engine, generator, transformer, and circuit breakers all in a common enclosed cabinet.

### DRAWING REFERENCE NUMERAL

308 440-volts Main Shutoff Switch
310 440-volts Circuit Breaker
313 110-volts Hot-leg
314 110-volts Hot-leg-2
315 Ventilation for Circuit-breaker Panel
316 110-volt Main Shut/off
318 110/220-volt Neutral Bar
319 Control Cabinet Doors
321 Control Cabinet Legs
334 220-volts Wire to Air-compressor Motor
335 220-volts Wire to Air-storage Heating Coil
502 Automatic Clutch-pulley Assembly
504 Automatic Clutch
506 Clutch Shift-lever
508 Air-regulator automatic Adjusting lever
510 Pulley Guard
512 Various Kilo-watt AC generator.
514 220-440-volt-AC Transformer
518 Circuit Breaker Control Cabinet
520 Recess Space with Holes to receive Weather Strip Center Support

### DESCRIPTION OF THE PREFERRED EMBODIMENT

Description

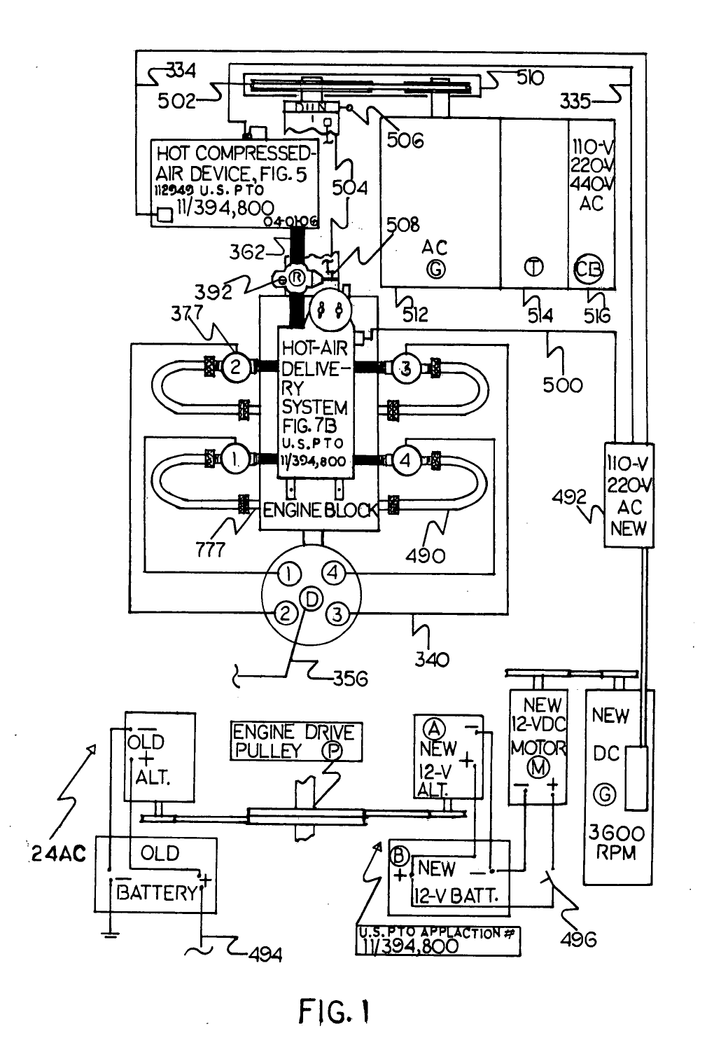

Referring now to the drawings and, in particular, to FIG. 1 Wherein there is illustrated a typical embodiment of a converted 4-cylinder gasoline automobile engine 24AC which is converted to an emission-free and non-fuel burning pneumatic engine. The said converted Pneumatic engine is covered in CO-pending continuation-in-part application Ser. No. 11/394/800 filed on Apr. 1, 2006. A 110/220-volt-AC generator 512 is added. An automatic clutch 504 is installed where an automobile transmission would normally be. The purpose of automatic clutch 504 is to allow the engine to operate at a low idle speed when there is no load on the generator. As the load increases clutch 504 will increase the engine speed by moving air-regulator lever 508 forward automatically. Optional transformer 514 can be installed to deliver 440-volt-AC. Circuit breaker cabinet 516 is added and wired to all commercially applicable electrical codes. While the preferred embodiment shows a 4-cylinder engine, any size or number of cylinders may be manufactured or used in this invention according to the amount of kilo-watts needed for the generator to apply to a load. The size and weight of device 24AC can also vary depending on the watts, space and application needed.

### DESCRIPTION OF THE ALTERNATE EMBODIMENT

Description

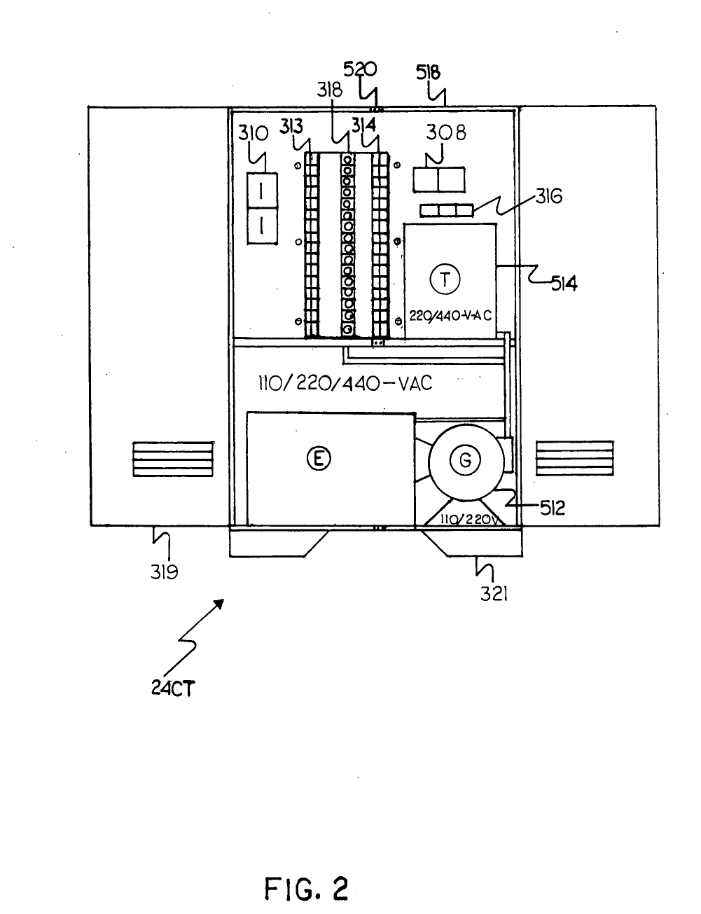

Referring now to FIG. 2 wherein is illustrated is a portable package electrical generator 24ACT, where all components described in the preferred embodiment and FIG. 1 are contained in a enclosure that can be used indoor or outdoor under various conditions, and purposes, such as the basement of a home, or outdoor, or for a commercial or industrial establishment. The present invention can also be used in the transportation industry or in power plants and such like applications.

### RAMIFICATION SCOPE AND CONCLUSION OF INVENTION

from the foregoing, it will be understood by persons skilled in the art that an improved multi-purpose non-fuel-burning non-harmful emission electrical power generator has been disclosed. The invention is relatively simple and easy to manufacture, yet affords a variety of uses. While the preferred embodiment shows a 4-cylinder engine, various numbers of cylinders can be used to accommodate various needs. The unit can come with or without a transformer. The units can utilize light weight materials for use on the transportation industry. The invention can be made small enough to be used in homes as a main or back-up source of energy. It can be used as a main or back-up energy source, in places like hospitals, and places that provide emergency services especially in a time of national or local disasters, and such like. The foregoing should be viewed as only an example of some of the uses of the present invention. Furthermore since numerous modifications and changes will readily occur to those skilled in the art, it is not desired to limit the invention to the exact construction and operation shown and described in its preferred and alternate forms. Accordingly all suitable modifications and equivalents may be resorted to falling within the scope of the invention. Furthermore the examples shown in the preferred and alternate forms are only to show examples of the principles of the invention and should not be regarded as limiting the scope of the invention in any way. Neither should the invention be restricted to the exact construction nor arraignment of component parts as illustrated in the accompanying drawings, or illustrated in the descriptive portions of the application.

1. What I claim is the new use of a converted automobile engine, which was converted from gasoline to a pneumatic engine and used to drive an electrical generator to supply 110/220-volts to a load which when coupled with a transformer, can also deliver 440-volts to a load comprising:
(a) providing in place of automobile transmission an automatic clutch arrangement which can vary engine speed and installed to said converted pneumatic engine with zero emission and fuel cost and
(b) Installing to clutch appropriate drive mechanism which can operate a rotary device and
(c) Providing a 110/200-volt generator with compatible rotary drive mechanism which mates with automatic clutch drive mechanism and
(d) Providing appropriate guard protection for said rotary mechanism and
(e) Providing optional 220/440-volt transformer which when assembled in proper manner can deliver 440-volt to a load and
(f) Providing circuit breaker cabinet wired to proper electrical codes Whereby as said pneumatic engine is operated said generator is placed in motion delivering 110/220-volts-AC to a load whereby said optional transformer can also deliver 440-volts-AC to a load.
